(19) United States
(12) Patent Application Publication
(10) Pub. No.: US 2012/0166616 A1
(43) Pub. Date: Jun. 28, 2012

(54) System and method for energy performance management

(75) Inventors: Michael Meehan, Lafayette, CA (US); Leith Painter, Sooke (CA); Daniel Labrosse, Victoria (CA); Tahseen Ur Rehman Fida, Victoria (CA)

(73) Assignee: ENXSUITE

(21) Appl. No.: 12/928,968

(22) Filed: Dec. 23, 2010

(51) Int. Cl. G06F 15/173

(52) U.S. Cl. 709/224

(57) ABSTRACT

A system for resource performance management, comprising a network-connected data collection service adapted to receive data from a plurality of resources, a network-connected data aggregation and reporting service adapted to aggregate resource-related data on at least temporal, organizational, geographic, and resource-specific dimensions, a network-connected initiative modeling service adapted to facilitate modeling by a user of a plurality of resource-related initiatives, and a network-connected initiative monitoring service adapted to receive data from one of the data collection service and the data aggregation and reporting service, and further adapted to measure performance of a plurality of resource-based initiatives, wherein a plurality of resource-based initiatives are assembled within the initiative modeling service into a plurality of initiative portfolios, and the plurality of initiative portfolios are modeled under a variety of forecast scenarios to determine an optimal initiative portfolio from among the plurality of portfolios, is disclosed.

### CROSS-REFERENCE TO RELATED APPLICATIONS

None.

### BACKGROUND OF THE INVENTION

1. Field of the Invention

The present invention is in the field of energy and environmental management, and in particular in the area of enterprise energy performance management systems.

2. Discussion of the State of the Art

It is well understood that large industrial enterprises use large amounts of energy, making energy one of the largest expense lines in industrial firms' budgets. It is not as widely understood, but is equally true, that large “information-centric” enterprises, such as banks and insurance companies, often also spend significant sums on energy. And with the continued growth of very large data centers, even pure Internet-based companies such as Google and Amazon are finding that one of their largest expenses is energy.

Additionally, an increased global focus on the environmental costs of energy usage has made the management of energy consumption by large enterprises even more important. There are several reasons for this, the first being financial. As energy unit prices rise due to growing demand in developing countries and (possibly) due to diminishing energy reserves, energy takes on an ever-greater importance in managing enterprise budgets. Secondly, regulatory impacts, both real in Canada, Nations in Europe, and Asia Pacific and expected in North America, are playing an increasingly large role in enterprise decision-making. As large enterprises are being required to obtain meaningful portions of their overall energy from renewable sources, and as reporting requirements are placed on energy usage and greenhouse gas (GHG) emissions, both direct and indirect, by enterprises, it becomes a legal requirement to closely track and audit energy usage and GHG emissions, as well as to reduce them. More and more national, regional, state, and local governments are making legally binding regulatory demands, and enterprises that wish to be transparent, compliant, and energy and sustainably competitive on a global scale have no choice but to respond. Finally, many large enterprises have recognized these trends and have taken steps to go beyond what is being required by regulators, taking bold steps forward into a carbon-sensitive economic and competitive framework in order to claim a place as leaders in environmental stewardship.

These trends all make it imperative that large enterprises not only learn to understand and economize their energy usage and GHG emissions, but also that they understand their overall direct and indirect impact on climate and other environmental issues, and that they actively plan to make continuous incremental improvements in energy efficiency and in selecting more sustainable energy sources and subsequent reductions in GHG emissions.

Acting responsibly in such a rapidly shifting regulatory and economic environment is very difficult using the tools available to most enterprises today. Relatively few enterprises understand their current actual energy usage in great detail, and even those who spend significant time on studying energy usage often limit their efforts to the most energy-intensive activities, such as industrial facilities and data centers. And basically no enterprises today track indirect energy usage and GHG emissions due to their activities, for instance as a result of their employee's daily commutes. And, while there exist some basic tools for studying an enterprise's energy economics, there is no application, platform, or toolset available today to allow enterprises to actively and intelligently measure their energy and environmental footprint in a way that allows them to explore many possible decision paths in the quest for finding an economically optimal set of decisions. In particular, most energy and environmental initiatives undertaken by enterprises today are done so generally in an ad hoc fashion, often with a group of initiatives around a theme lasting for a short while, to be replaced by others later. For example, an enterprise may receive a mandate from its top management to “reduce energy consumption by 30% over the next two years”, and dozens of local and a few enterprise-wide initiatives spring up for a short time. Perhaps a year later, the attention in the media to anthropogenic global warming leads to a new mandate such as “we must reduce our green house gas emissions in scope 2 and scope 3 categories by 20% over the next 2 years and produce a Climate Disclosure Project report that is auditable”. If financial investments were to be made in such a jingoistic, follow-the-leader way, our economy would be even more difficult to predict than it already is; the availability of a discipline of financial engineering, and of tools such as portfolio and asset management, make the financial sector far more deliberate in its decision-making processes.

It is an object of the present invention, therefore, to provide a system and method for enterprise energy performance management (and sustainability performance management) that allows enterprises to use familiar financial methodologies such as portfolio analysis to understand the complete picture of their energy and GHG footprint, and in order to intelligently evaluate and choose among competing initiatives for improving energy performance in order to achieve an optimal return while reducing risks.

### SUMMARY OF THE INVENTION

In a preferred embodiment of the invention, a system for resource performance management, comprising a network-connected data collection service adapted to receive data from a plurality of resources, a network-connected data aggregation and reporting service adapted to aggregate resource-related data on at least temporal, organizational, geographic, and resource-specific dimensions, a network-connected initiative modeling service adapted to facilitate modeling by a user of a plurality of resource-related initiatives, and a network-connected initiative monitoring service adapted to receive data from one of the data collection service and the data aggregation and reporting service, and further adapted to measure performance of a plurality of resource-based initiatives, is disclosed. According to the embodiment, a plurality of resource-based initiatives are assembled within the initiative modeling service into a plurality of initiative portfolios, and the plurality of initiative portfolios are modeled under a variety of forecast scenarios to determine an optimal initiative portfolio from among the plurality of portfolios.

In yet another preferred embodiment of the invention, a method for managing resource performance, comprising the steps of (a) collecting data pertaining to resource usage from a plurality of resources, (b) analyzing the data including at least an analysis of environmental impact of the resource usage represented by the data, (c) formulating at least one goal relating to improvement of resource usage or its effects, (d) modeling a plurality of resource-based initiatives, (e) assembling a plurality of initiative portfolios from the plurality of resource-based initiatives, (f) modeling future performance of each of the plurality of initiative portfolios, (g) selecting from the plurality of initiative portfolios an optimal portfolio, based at least in part on the results of the modeling future performance, (h) implementing the resource-based initiatives associated with the selected initiative portfolio, and (i) monitoring the performance of the plurality of implemented initiatives at least in part to measure the improvements in resource usage or environmental impact actually achieved by the initiatives implemented, is disclosed.

### BRIEF DESCRIPTION OF THE DRAWING FIGURES

FIG. 1 is a block diagram of a system for energy performance management.

FIG. 2 is a block diagram of a preferred embodiment of the invention.

FIG. 3 is a block diagram of another preferred embodiment of the invention, showing exemplary service elements in more detail.

FIG. 4 is a block diagram of another preferred embodiment of the invention, showing an exemplary architecture by which the goals of the invention may be realized.

FIG. 5 is a process flow diagram of a method for energy performance management according to a preferred embodiment of the invention.

FIG. 6 is a process flow diagram of another preferred embodiment of the invention in which automated baseline or base year recalculations are performed.

FIG. 8 is a process flow diagram highlighting alternative the dynamic nature of process flows that may be undertaken, according to the invention.

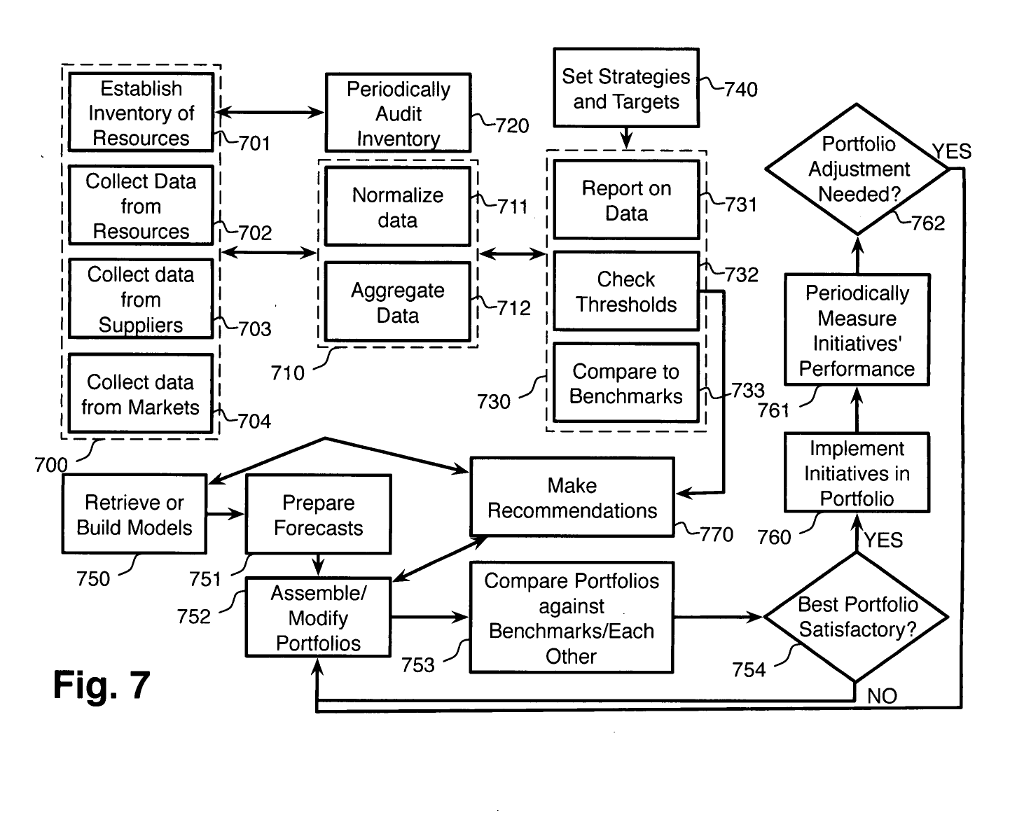

### DETAILED DESCRIPTION

The inventors provide, in a preferred embodiment of the invention, a system for energy and sustainability performance management that allows managers of an enterprise to understand the full range of impact of their business activities in terms of energy usage and environmental impact, and in general on the sustainability of their business activities (that is, its effects on resource depletion, environmental impact, climate change, and related aspects of sustainability). While the embodiments described herein pertain primarily to energy usage and the associated environmental impacts resulting therefrom, the portfolio-based management of a range of possible initiatives can also be used to monitor and manage other environmentally important resource-related aspects of an enterprise's business, such as its impact on local water economics, sewage and waster water generation and handling, solid waste generation and handling, and so forth.

The general approach envisioned by the inventors is to divide the problem into four distinct sub-problems that can be addressed by methods of doing business and appropriate applications. These sub-problems are: data collection; data aggregation, summarization, and reporting; initiatives exploration, definition, and analysis; and initiative execution and monitoring of initiative performance against specified targets or goals.

In a preferred embodiment, an enterprise-scale data collection system obtains data pertaining to past, present, and expected future energy consumption. The data is collected from a wide variety of sources, many of which store only partial data (such as electrical usage in kilowatt-hours at a particular facility, without information on the source of the electricity in question), and often data from different sources will be obtained in formats that are incompatible with each other. Quite often, formulas are used to compute data from sources, as for instance when a utility reports a percentage of electrical power delivered that was derived from renewable sources; where possible such formulas should be obtained as well to ensure that all data can be normalized across the enterprise.

It will be recognized by those having ordinary skill the art that there are many forms of data transmission and data encapsulation available in the art, any of which may be used, in any combinations, according to the invention. For example, in some embodiments historical data is uploaded in a bulk operation from a source (such as a utility, which might provide several years' worth of past bills), and then periodically refreshed via bulk uploads (for example, nightly bulk downloads of each day's utility billing data). In other embodiments, data is retrieved from sources in real-time or, for example by collecting fifteen-minute interval usage data from Google Power Meter via its API, or collecting fifteen-minute interval usage data directly from an advanced metering infrastructure (AMI) provider. In yet other embodiments, data is collected in real-time directly from building control systems using any of several well-defined and established data interchange standards (e.g., BACnet or LONworks). In some cases, data will be collected manually, such as when fuel storage tanks in a remote facility are not equipped with automated sensors; in such cases the data gathered is entered manually via a web-based user interface. All data collected is stored in an energy performance management (EPM) database, which may be a standalone relational database management system operating on a dedicated database server, or any of the many well-known database architectures known in the art. In a preferred embodiment, data is stored in a hosted, or cloud-based, database system configured in a master-and-slave architecture. It is a goal envisioned by the inventors that embodiments of the invention shall be capable of collecting substantially all energy-related usage data from throughout an enterprise, and of normalizing the data from its many sources and formats into a single logical EPM database.

A second core function provided by a preferred embodiment of the invention is data aggregation, summarization, and reporting. Data from the EPM database is aggregated along several key dimensions. One of these is a standard dimension well-known within the art of business intelligence systems, namely time. In preferred embodiments, data is available for any fifteen-minute, half-hourly, daily, weekly, monthly, quarterly, or annual time periods. In addition, preferred embodiments of the invention allow for custom time aggregates. An important second set of dimensions for data aggregation are organizational dimensions. In a preferred embodiment of the invention, a rich organizational modeling capability is provided that allows for multi-level, hierarchical or non-hierarchical organizational structures to be modeled. In some embodiments, organizational models are based on facilities, with each facility being assigned to a specific business unit; of course business units may be organized into a hierarchical structure. So for example a small production facility may be assigned to a particular product line, which itself may be assigned to a specific profit center, which may then in turn be assigned to a national general manager-level business unit. In other embodiments, facilities may be further subdivided and the subfacility-level entities assigned to different business units. Thus a particular facility belonging to an enterprise might have an office building that is used by corporate accounting, sales, and marketing departments and a divisional headquarters operation, and it may also have a manufacturing and test facility that is dedicated to a single product line. It will be appreciated by one having ordinary skill in the art of business intelligence that there are many ways to aggregate data pertaining to any aspect of an enterprise, and it is envisioned by the inventors that any of these ways may be applied to the aggregation of energy and environmental impact data according to the invention.

Another important dimension in aggregating energy and environmental impact data is geographical. It is envisioned by the inventors that a preferred embodiment of the invention will allow independent assignment of geographic information to each facility, and that the geographic aggregation will be flexible. What is fairly unusual about energy and environmental impact data is that there are numerous very specific reporting requirements that extend outside the enterprise. For example, some regional energy initiatives within the United States require regular reporting of energy and environmental impact data pertaining to the applicable region (which may and in most cases will be different from the organizational region boundaries). Since each state may have its own reporting requirements (or its own energy sourcing or efficiency requirements that must be managed and therefore require at least internal reporting), and in some cases even intrastate entities or entities that span parts of multiple states, it is important that each facility or energy resource may be assigned to a plurality of distinct geographical units, some of which may aggregate into higher-level geographic entities while others will be “stand alone”. For example, there are energy initiatives in place in the Delaware Valley Regional Planning Commission, which encompasses a few counties in Pennsylvania and New Jersey; each of these states also has its own requirements and initiatives and the states are part of large regional initiatives.

Yet another important dimension in aggregating energy and environmental impact data is based on the relationship of the source to the enterprise. Many regulatory agencies and industry standards use a set of three “scopes” to describe the possible relationships, and in general this is the way the “source relationship” is viewed according to most embodiments of the invention, although more finely-grained (and therefore more complex) approaches could be used without departing from the invention. According to most definitions, “scope 1” refers to energy or environmental impact—typically GHG emissions—that is tied directly to the economic activity of the enterprise; for instance, exhaust gases from a manufacturing facility, or energy consumed to melt raw materials while making steel, when the energy comes from a source within the enterprise (often, coal is delivered directly to steel mills along with other raw materials, and the heat required is generated “in house”). Scope 2 refers to energy that is delivered by purchased electricity, steam, or heat; for example, when aluminum smelters and data centers purchase large amounts of electricity from a utility, to the smelters and data centers the emissions resulting from the generation of that electricity (if any) would be classified as scope 2. In a sense, scope 2 can considered direct use of energy, but indirect emission (the energy is “used” by the enterprise, but the emissions were “made” elsewhere). Finally, scope 3 refers to truly indirect energy associated with an enterprise's business activities. For example, GHGs are emitted by cars as employees commute to work each day; in some regulatory regimes it is considered desirable to allocate a portion of consumer-generated emissions to enterprises by attributing the environmental impact of its employees' commute to the enterprise.

Unlike many business intelligence systems known in the art, the many different types of aggregation required for an enterprise energy performance management system often come with different definitions of what key concepts mean. For example, GHG footprints for energy usage may be calculated in many different ways, and different entities may require reporting using different computation formulas or reporting units, or both. In a preferred embodiment of the invention, EPM users are able to specific custom formulas for use, and specific units for use, for any given aggregation. For example, it may, within a global enterprise, be desirable to calculate emissions in the US using a formula such as

Emission=Energy*Emission Factor*Global Warming Factor,

while in reports to the UK Department of Environment, Food, and Rural Affairs it may be desirable to calculate, for emissions in 2010 and later, using the formula

Emission=Energy*Emission Factor

(since, for 2010 and later, Defra emissions factors already include the GWF; note that prior years would be reported using the first formula). To accommodate the intrinsic complexity posed by such a wide variety of aggregation dimensions (and granularities), each potentially with its own units and formulas and reporting requirements, the inventors have conceived a preferred embodiment of the invention in which custom formulas can be created and added to a formula library, and then for each report or aggregation activity, different formulas can be selected for different report elements by an EPM user using common user interface conventions (for instance, in an embodiment formulas would be available using pull-down menus configured such that only relevant formulas would be available for selection for any given report element).

In preferred embodiments, a rich set of visualization tools is provided to EPM users to view aggregated data. Standard tabular reports common in the art are supplemented by geographical views superimposed on maps, in which particular energy performance data (historical, current, forecasted, or some combination of these) can be viewed by clicking on an applicable geographical region (of any size or hierarchical level: international region such as the EU or the Nordic Countries, nations, intranational regions (such as the Western Climate Initiative), individual states or provinces, smaller regions such as the aforementioned Delaware Valley Regional Planning Commission), or metropolitan regions. In some embodiments, a pull-down list of hierarchical levels or types is provided, the use of which causes a selected level of highlighting (and click-through capability) to be enabled on a map. For instance, if “small regional entities” was selected, then entities such as the counties comprising the Delaware Valley Regional Planning Commission or the counties comprising Puget Sound Regional Council would be highlighted and available for “click-to-view” report viewing.

A third core element of the Energy Performance Management system of the invention is initiatives exploration, definition, and analysis. The concept of an initiative within the context of the invention refers to a planned series of actions intended to reduce energy usage, improve energy efficiency, shift energy usage to more sustainable sources, mitigate the emission of GHGs resulting from planned energy usage, and the like (of course, any given initiative can be aimed at delivering one or any number of these benefits, according to the invention). Many possible initiatives in the areas of energy management and environmental improvement are well-known. For example, in many enterprises a wholesale shift to low-wattage light bulbs has been undertaken as a “quick fix” that brings both financial returns (they use less energy) and environmental benefits (they have a smaller GHG footprint). Other examples include adoption of solar for some facilities (typically justified by a facility-specific return-on-investment calculation), adoption of motion or presence sensors to keep rooms dark when no one is using them, and so forth. Generally, however, such initiatives are ad hoc, and they are generally evaluated in isolation from each other. According to a preferred embodiment of the invention, enterprise users are provided with a rich set of modeling, visualization, and analysis tools that allow them to create candidate initiatives, model their likely impacts and the risks associated with them, including analyzing scenarios concerning possible future events that could impact the initiatives' returns or risks. For instance, an initiative to build solar collection facilities on all buildings over a certain size within the enterprise could be created within the system of the invention. Users are allowed to specify various parameters needed to estimate the cost of implementing the initiative, as well as to model expected returns. In the solar collectors example, the current price of solar collectors, and the cost of construction to deploy them, can be modeled. In addition, forecasted values of solar collectors, and forecasted costs of utility-generated electric power (which will be offset by the solar collectors, and so constitute one of the benefits of the solar collectors), can be entered. An initial model of the cost of deploying the initiative can be made directly from the inputs gathered, and a forecast of future returns under nominal conditions can be created. It will be appreciated by those having ordinary skill in the art of project valuation and financial decision analysis that there are several well-established methods of valuing the future returns, including for example straight payback analysis, discounted cash flow analysis, and real options analysis. Any of these, or any other, financial valuation approaches may be used according to the invention.

As part of the initiative creation and analysis process, it is important for enterprises to be able to explore the likely consequences of potential events that could affect the value of any given initiative. Taking for example the solar collector example, part of the value of this initiative might stem from its enabling an enterprise to meet a state or federal regulatory requirement concerning renewable energy credits (for example, a state might require each enterprise over a certain size to received at least 20% of its energy resources from renewable sources). In such a case, the value of complying with regulatory requirements, which could involve tax incentives or punitive levies for non-compliance, may act to offset a weak direct economic impact of an initiative, so possible changes in regulatory requirements may be modeled according to the invention. Moreover, in some cases an initiative may be alternatively located in several different locations within an enterprise, each of which may be subject to different regulatory regimes (often of very different kinds), and each of these regulatory regimes may be subject to rapid change based on shifting political winds. By enabling an enterprise to effectively model and predict the impact of various possible future changes (other examples could include a rapid rise in utility-generated power costs, or a rapid drop in natural gas prices, and so forth), the invention allows enterprises to minimize the risk of ultimately having large stranded costs (as happened in the late 1970s when many agencies and enterprises invested large sums of money in various alternative energy initiatives that were left as stranded economic waste when the price of oil collapsed in the 1980s and a conservative regulatory climate prevailed).

In a preferred embodiment of the invention, a user is able to combine a series of initiatives into a portfolio, and to analyze the expected returns, risks, and resilience in the face of regulatory or economic changes for the portfolio as a whole. By assembling initiatives into one or more portfolios, users are enabled to take advantage of well-known asset management techniques to minimize the overall portfolio risk while optimizing the returns for a given level of risk. This is particularly true, of course, when initiative returns and risks are driven by variables or factors that are not strongly correlated. For example, in a strong carbon regulation regime, carbon prices and oil prices might be negatively correlated (since high carbon prices will depress demand for oil, which could result in lower oil prices); on the other hand, a weak regulatory regime with low or negligible carbon prices might have only a modest impact on oil prices but a very large impact on the value of alternative energy projects (whose value often is largely made up of regulation-derived elements, rather than direct economic elements, especially when the direct costs of the alternative energy sources are higher than “dirty” fuels such as oil and coal). According to the preferred embodiment, enterprise users are enabled to model each initiative including how the costs and benefits of the initiative vary based on other, often extrinsic, factors. Users are also enabled to create scenarios for the future behavior of such other factors, for instance by entering a custom formula or directly importing a table of data to provide a prediction for the future price of oil. By building a library of such forecast models, and possibly even building alternative models for one or more initiatives (typically where the costs and returns themselves are highly uncertain, as when adopting a new alternative energy source), an enterprise user is able, according to the invention, to run any number of complex “what if” scenarios; for example, a user may select from a library a modeled carbon price forecast, a modeled oil price forecast, a modeled forecast for the regulatory requirements for renewable energy use, and a modeled general enterprise economic forecast (in order to drive absolute forecasts, it is necessary to estimate the economic output of the enterprise; this is not needed when performing intensity forecasts, which are also possible according to the invention), a user may then “run the scenario” to compute expected costs and benefits of the initiative under the given set of models. Obviously a user could perform an essentially infinite number of scenarios, given enough models have been generated, and the actual number that will be performed in any given situation will depend on the size of the initiative, the level of risk it entails, and the resources available for such work. What is important, though, is that invention makes it possible for an enterprise to perform open-ended analysis and does not impose any limits on number of models, number of variables, length of time to be modeled, formulas to be used and so forth.

According to a further embodiment of the invention, complex events that affect many variables may be modeled directly and separately from those variables. For example, an event labeled “OPEC Oil Embargo” could be created, and an estimate made of the impact such an event would have, in percentage terms, on oil prices, regulatory costs, natural gas prices, economic activity, and so forth. The goal is to capture the best available estimates, from experts within or without the enterprise, of likely impacts of a rare complex event, and then to enable users to test the robustness of a given portfolio of initiatives against unlikely but possible events (other examples would include general breakdown in international trade, a major terrorist attack that changes transportation and political patterns, or a major climate shift that required dramatic and sudden shifts in energy usage). According to the embodiment, a user can then assemble a portfolio of initiatives, model it under various “most likely” scenarios, and then apply to these scenarios one or more major events, at various times selected by the user, to model how the portfolio would perform under disruptive conditions.

As a result of the rich initiative and portfolio creation and modeling capabilities made available by the invention, it is possible for enterprises to carefully evaluate a large number of potential energy and environmental initiatives rigorously, in order to select a portfolio of initiatives that delivers an optimal return with acceptable risk. It is likely that such a portfolio would differ significantly from current energy initiative footprints in large enterprises, in which energy and environmental initiatives are rarely coordinated and are not selected based on sound financial analysis. Furthermore, it is likely that an optimal portfolio would consist of a basket of initiatives, some of which delivered direct bottom line results that are independent of extrinsic factors (conservation programs tend to fall into this category), some of which rely on existing regulatory requirements (for example, for increased use of renewables), and some of which provide limited benefits under current conditions but hedge against possible changes (for instance, some initiatives might be focused on increasing use of natural gas, which is more abundant than ever; such initiatives might be very important if a government came to power that dismantled even existing regulatory programs in favor of laissez faire economics).

Finally, the fourth core element of the preferred embodiment of the invention is the monitoring and evaluation of initiatives that are selected for implementation. According to the embodiment, data pertaining to the energy resources affected by the initiative continues to be collected (or, if new resources are added, data collection is started), and fed into the EPM database. This function has already been briefly discussed above. As time progresses, actual performance of systems affected by an initiative is displayed to an enterprise user, who is provided with analytical tools to assess the effectiveness of the initiative in achieving its target goals. For example, if an initiative called for certain conservation measures to take place, then actual energy consumption following implementation of the initiative is compared to energy consumption before implementation of the initiative. Or, if certain solar collectors were added as one initiative and certain contracts put in place as part of another, both intended to raise the percentage of energy consumed by an enterprise that is derived from renewable sources, then a measure of effectiveness is clearly the rate and amount by which the percentage of total energy consumption derived from renewable sources has increased since implementation of the initiatives.

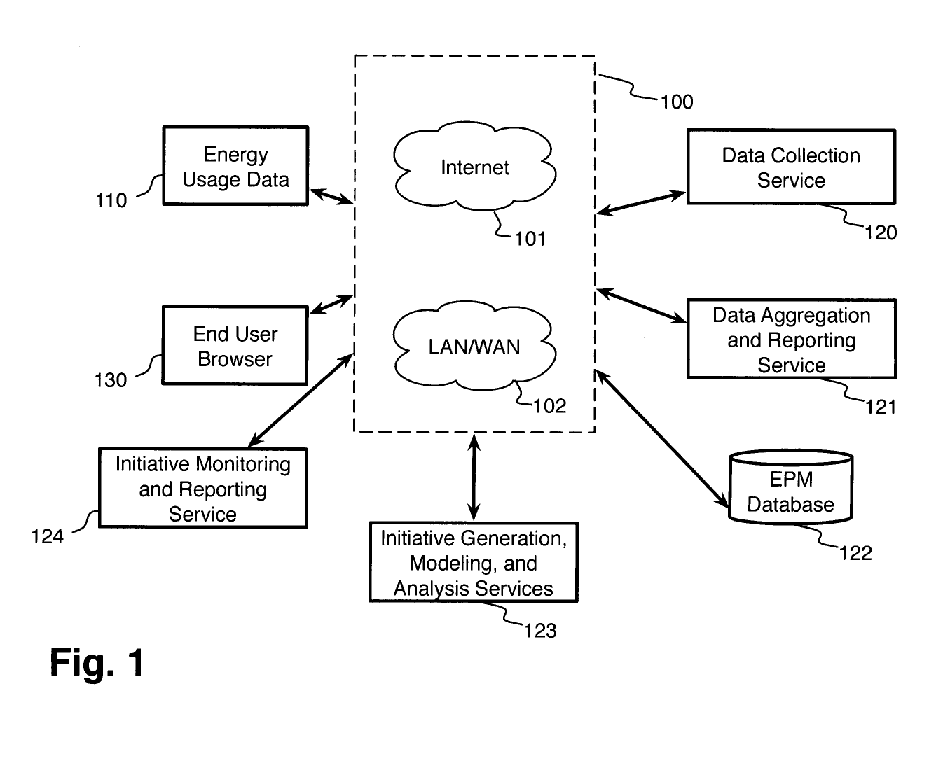

FIG. 1 provides a block diagram of a preferred embodiment of the invention. As an initial matter, communications within the system of the invention is generally conducted over a packet-based network such as the Internet 101 or a local area network or wide area network (LAN/WAN 102), although many other possibilities exist, as will be recognized by one having ordinary skill in the art of web application design and development. To simplify FIG. 1, generalized network 100 is drawn as surrounding the Internet 101 and LAN/WAN 102; the intent here is to indicate that all of the applications hereinafter referred to communicate with each other across a plurality of packet-based data networks, some of which may be public and some of which may be private. Any combination of networks may be used according to the invention without departing from the scope of the invention.

As part of the data collection function described above, data is collected by a data collection service 120 from a plurality of energy usage data sources 110. Energy usage data 110 may be derived from direct measurements of energy generating or consuming devices such as generators, solar collectors, motors, lighting panels, data center power systems, and any of a myriad of other electrical and electronic devices adapted to transmit energy usage or generation data over a data network 100. Energy usage data 110 may also comprise bulk-loaded data from third-party sources, such as historical billing records obtained from a utility, or historical energy usage data for a region obtained from a public database of economic records. As mentioned above, many sources of energy usage data 110 will reside within an enterprise, including even manual sources such as measurements of remote meters or fuel tank levels and entry via a web-based data entry interface. Similarly, many sources of energy usage data 110 will be from outside an enterprise, either from energy providers or consumers directly, from publicly-available databases, or from third-party data providers of many possible types. It will be appreciated by one having ordinary skill in the art that the invention is not limited to any particular energy usage data 100 sources.

In a preferred embodiment of the invention, data collection service 120 (and indeed all of the other services of the preferred embodiment are as well) is a web service based on the REST architectural concept (which stands for Representational State Transfer). This approach makes best use of recent highly scalable Web 2.0 architectures, but it is not required in all embodiments, and indeed Web 2.0 paradigm itself is not central to the invention, although it is used in a preferred embodiment. It should be well understood to one having ordinary skill in the art of web application development that there are many well-established and emerging architectural approaches, including but not limited to Java Servlets, .NET, traditional client/server, and the like, and any of these architectural approaches may be used to implement a system according to the invention, or to carry out methods of the invention. Also, the term “service” used in reference to system components such as data collection service 120, refers to a web service or, more generally, an automated service carried out by a network-attached general purpose computer using a standard set of service interfaces. Such “services” are invoked by other automated services over a plurality of networks 100 (for instance, initiative monitoring and reporting service 124 will, in some embodiments, automatically invoke services delivered by data aggregation and reporting service 121), or by users (i.e., humans, generally via an end user browser 130, and again mediated by a plurality of networks 100). The use of web services is not, however, essential to the invention conceived by the inventors, and general-purpose computer servers could be used interchangeably with services such as data collection service 120 without departing from the scope of the invention.

Data collection service 120, on receiving energy usage data 110 from a plurality of sources, may optionally perform several data validation steps before committing the data to an Energy Performance Management (EPM) database 122. For example, data integrity could be checked against various constraints, and data de-duplication could be performed. In some cases, some data elements may be missing, as for example when periodic readings of a parameter are taken; in such cases, a variety of methods known in the art for handling the situation may be used, according to the invention. In some cases, linear or other interpolation may be used to “fill in” missing values, where it is reasonably clear that the underlying system represented by the data does not change radically. In other cases, missing data elements may be populated by zero data elements; it will be understood that there are any number of ways of handling missing data elements, and none of these is preferred over any others by the inventors. In some cases, data readings may be received by data collection service 120 that are nearly but not quite periodic or that represent more readings than are desirable; for instance, if readings are sent frequently from a current transformer (which measures current flow in real time), it may be desirable for data collection service 120 to normalize the data to periodic (for instance, every 15 minutes) readings, so that it can be synchronized with other data commonly collected in a periodic fashion. Again, no particular method among the many known in the art, including interpolation, moving averages, and static averages over fixed time periods, may be used according to the invention.

EPM database 122, as noted above, may take many different architectural forms, and may be located on a single general purpose computer, on a cluster of general purpose computers with well-known clustering software in use to allow the clustered machines to appear to other machines as if they were a single machine, a master-and-slave architecture in which a slave database machine maintains a copy that is kept current of the data stored on the master database machine and is available for immediate use in case of loss of connection by a client to the master database machine, and so forth. Again, it will be obvious to one having ordinary skill in the art of database management that there are many physical and logical variations that can be used to instantiate an Energy Performance Management (EPM) database 122, and any of these may be used.

Referring again to FIG. 1, the second core function described above of systems and methods using the present invention—the data aggregation, summarization, and reporting function—is carried out by a data aggregation and reporting service 121. Again, while in a preferred embodiment this service is implemented as a RESTful server, it can be implemented according to the invention in a variety of ways without departing from the intent of the inventors. Data aggregation and reporting service 121 performs both scheduled and on-demand services. Periodic data aggregation is commonly performed on a scheduled basis, for example. And, as is common in most software applications, scheduled reports are automatically generated and delivered via email to subscribers. Examples of such reports include daily, weekly, monthly, and quarterly energy usage reports and monthly initiative progress reports; of course, any number of reports can be configured and subscribed to by users of data aggregation and reporting service 121. In other cases, users may directly interact, generally via end user browser 130, with data aggregation and reporting service 121 to explore data in more depth. For instance, in some embodiments maps are provided to allow users to interactively explore how energy usage and environmental initiatives are progressing in different geographical regions in which an enterprise operates. In some cases data aggregation and reporting service 121 limits access to particular reports based on an identity of a requested user; such role-based access control to potentially sensitive data is well-known in the art. In general, any security measure known in the art can be combined with any of the services described as embodiments of the invention without departing from the invention; it is not the inventors' contention to have invented anything, nor to be limited by anything, having to do with web application security. In some embodiments of the invention, reports can be filtered along any relevant data dimension. For example, a user may subscribe to a regularly scheduled report showing carbon reductions in European facilities of an enterprise, and a user may ask for an ad hoc report of the last four quarters' carbon reductions in Western Europe in particular. In general, data aggregation and reporting service 121 is capable of filtering along one or more of temporal, geographical, or organizational dimensions. In some embodiments, finished reports are stored in read-optimized datamart or business intelligence cube. Also, it is common in the art for business intelligence applications to make use of three types of databases. Raw information is extracted from transactional databases, transformed into pre-aggregated data elements along several data aggregation dimensions, and then loaded into a datamart or infomart that is optimized for fast reading by many report or analytics users. For the purposes of describing embodiments of the present invention, these various database elements are considered to be part of an EPM database 122; without loss of generality or applicability they could be subdivided in the normal way just described. However, since the invention is not fundamentally about new ways of organizing data within a database, all of the possible configurations are considered to be included in the generic term EPM database 122.

In a preferred embodiment of the invention, a number of key functions are provided by web-based initiative generation, modeling, and analysis services 123. One of these is the ability to define an arbitrary number of initiatives to be considered. Initiatives are goal-oriented sequences of actions or investments that can be undertaken by an enterprise to pursue energy conservation, energy diversification, GHG footprint reduction, reduction in wastewater generation, and the like. According to the invention, an enterprise user, operating via an end user browser 130 (such as Internet Explorer, Apple Safari, Firefox, Google Chrome, or the like), may create new initiatives via initiative generation, modeling, and analysis services 123, provided the user has sufficient access rights. An initiative initially consists of a name and a stated goal, and is stored in EPM database 122 once created. Usually, the creating user will move on to the next step, which is to build a model for the initiative. The model, which is developed using a series of web forms served by initiative generation, modeling, and analysis services 123, is very analogous to a project plan in traditional project management techniques. It consists of a series of implementation steps and associated costs, and it includes expected returns and how they will be measured. For example, if an initiative named “Industrial Storm Drainage Capture” is created to “capture storm drainage and use to generate electricity at selected industrial facilities”, it might have initial steps such as “Perform site review of largest industrial facilities”, with an output of “prioritize sites based on expected power generation” (which would be a function of the topography and typical rainfall at each site), and an associated cost. Additional steps could include steps such as “Finalize selection of facilities”, “Let contracts for installation of drainage and power generation equipment and associated circuitry”, and finally “Bring systems online and reduce utility-generated electrical demand by 5% at selected facilities”. As is typical in most enterprise projects, this hypothetical project involves considerable up-front cost, but has the potential to generate cash flow once storm drainage is captured and used to generate electricity that can offset utility-generated electricity. Thus, like most investment decisions, an enterprise considering this initiative would need to look at the costs likely to be incurred (including how much must be risked before project viability can be determined; until site surveys are done it may not be possible to know how much power could in principle be generated this way), and it would need to look at the expected revenues (in this case, it would be more accurate to say “cost reductions”, since utility bills will be lowered) to be obtained. Assuming such systems are durable, it can be anticipated that, after some period of time, the initiative in question will become “cash flow positive”. Of course, as mentioned above, there are several well-known ways in the art of managerial finance for evaluating an investment opportunity, from simplistic pay-back analysis, through discounted cash flow analysis, to more sophisticated real options analysis. Any or all of these techniques can be provided by initiative generation, modeling, and analysis services 123.

But of course, there are other factors beyond traditional financial factors involved in initiatives such as the example just described. For example, is several of the states in which an enterprise has industrial facilities have established mandatory renewables percentages (that is, percentages of total energy consumption that is derived directly or indirectly from renewable energy sources), an initiative to capture storm drains and use them to generate electricity may have more value as a means for increasing the renewables percentage than it saves in direct energy cost savings. Capturing these benefits (or conversely characterizing the risks of not meeting the regulatory targets, and valuing the exemplary initiative as a risk mitigation investment) is more complicated than traditional investment analysis of an infrastructure project. And the situation becomes even more difficult when one wishes to analyze a potential portfolio of initiatives, some of which reduce regulatory risk in one area while others reduce regulatory risk in a different area (and maybe several overlap as well), while yet others do not address regulatory risk at all but simply deliver direct bottom line benefits. In order to enable enterprise users to effectively address such issues, initiative generation, modeling, and analysis services 123 provide a capability, according to an embodiment of the invention, for an end user to assemble several initiatives into a portfolio, and to analyze the expected performance of that portfolio as a whole. One benefit of this approach is to capture a well-known financial benefit of portfolios in general, specifically that an overall risk level of a portfolio may actually less than any of the risks associated with any one of the portfolio's components, particularly if underlying factors (contained in models generated by initiative generation, modeling and analysis services 123) of a plurality of portfolio components are inversely or at least poorly correlated with each other.

By providing an ability to create initiatives, to model them in order to identify key parameters that drive their risks and rewards, and to assemble them into prospective portfolios of initiatives, initiative generation, modeling, and analysis services 123 make it possible for an enterprise user to iteratively and dynamically explore a solution space to find an optimal portfolio of initiatives that delivers a solid rate of return within a tolerable level of risk. Additionally, in some embodiments, extrinsic factors or external events can be modeled separately using initiative generation, modeling, and analysis services 123, in order to allow an enterprise user to create a library of such extrinsic factors or external events, characterized by a set of variables or parameters they are expected to influence, that can be stored in EPM database 122 and used as needed. An example of using such an extrinsic factor or external event would be to model how a particular portfolio would react if Iran initiated a war with the Arab countries in its neighborhood, causing a severe spike in oil prices, a reduction in supply, and likely a dramatic change in regulatory requirements as Western governments tried to mitigate the impact of the event. The results of such an event are not certain, but good estimates of the types of impact can be made by an experienced user (or by a third party as part of an enterprise's risk management function). Similarly, it would be imprudent for the base models of any given initiatives to include such an event, and each portfolio is modeled as the collection of base initiative models that it is, and so does not normally model unlikely events such as war in the Middle East. Thus, in normal planning modalities consideration of such events would not be normal, yet we all know that such events do occur, albeit unpredictably, so it is important for users to be able to understand how such unlikely events would affect planned energy and environmental initiatives.

According to an embodiment of the invention, initiative generation, modeling, and analysis services 123 also provide a capability for users to run configurable scripts which automatically iterate through a series of scenarios for a plurality of initiatives or portfolios, in order to automate the process of searching through a wide range of potential initiative mixes in order to find an optimal (or at least most closely optimal) portfolio in which to invest. In some embodiments, scripts are specified by describing a range of values which key parameters (such as the price of oil) take in successive runs or iterations, while in the same or other embodiments it is possible to create forecasted “parameter vectors”, each consisting of forecasted values of a given parameter for each of a predetermined future time periods. Parameter vectors may be formed manually by entering data in a table in end user browser 130, automatically by bulk import from a spreadsheet, or automatically using a formula that may be obtained from a formula library made available through initiative generation, modeling, and analysis services 123. According to preferred embodiments of the invention, once users have conducted a desired amount of analysis and robustness testing using extrinsic factors or external events, users are able to select initiatives for implementation that are predicted to yield good returns while maintaining risks to the enterprise at a satisfactory level.

Referring again to FIG. 1, initiative monitoring and reporting service 124 enables users of an enterprise to closely monitor the progress of a given initiative or portfolio of initiatives as it is implemented. Using data collection service 120 to gather energy usage data 110 from affected energy resources, or simply retrieving required data from EPM database 122, initiative monitoring and reporting service 124 presents users with a summary of costs and benefits to date from each given initiative or portfolio of initiatives, and it allows comparison of actual results against forecasted results. Additionally, in some embodiments initiative monitoring and reporting service 124 allows revised forecasts of initiative or portfolio returns and risks to be generated as new data is gathered, so that a likely cumulative effect of any deviations from an original plan or forecast is made evident. Additionally, in a preferred embodiment initiative monitoring and reporting service 124 provides alerts to appropriate users when an initiative or portfolio has been determined to be deviating from its forecast by some predetermined amount, or alarm set point. Notifications can be by email, using an automated email notification service, or instant message, or indeed any scriptable communications medium that is appropriate for the users in question.

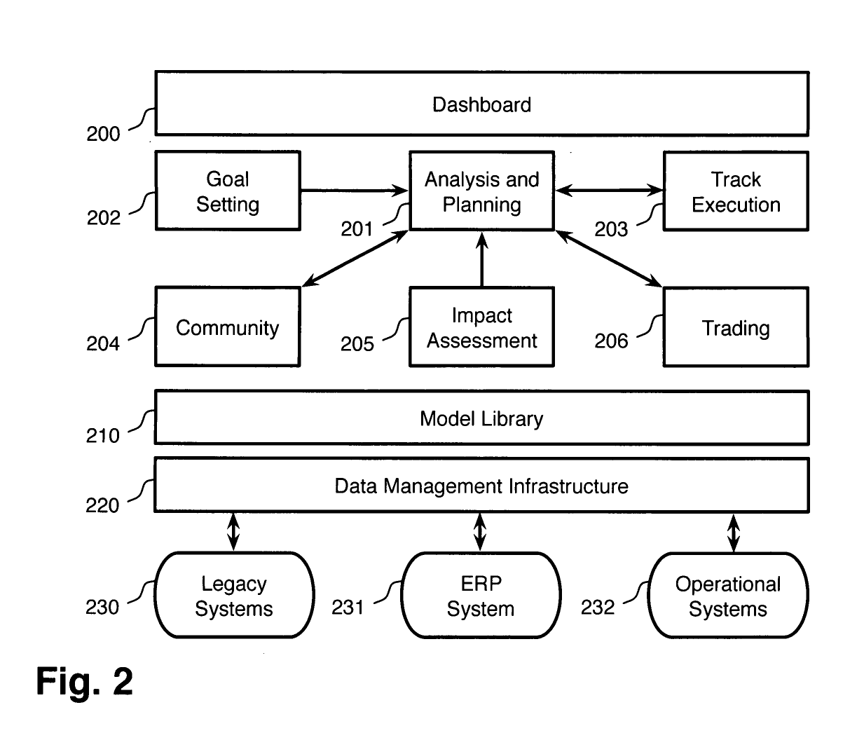

FIG. 2 provides a block diagram illustrating functional relationships between different activities or entities involved in enterprise energy performance management (EPM), according to a preferred embodiment of the invention. Users interact with EPM systems of the invention through dashboard 200, which generally is delivered to users via end user browser 130, but which can be delivered as dedicated client software applications or mobile applications. It will be appreciated by one having ordinary skill in the art of user interface development that there are many ways of providing dashboard-like functionality to end users on various devices or classes of devices, any of which may be used to present dashboard 200 according to the invention. Dashboard 200 presents a comprehensive set of windows, tabs, or menu options to allow each user, according to privileges granted by their role or their individual identity (using normal role-based access security or user account controls, both of which are very common in the art). Among the first activities likely to be undertaken by users when working with an EPM system according to the invention is goal setting 202. Goals are generally set based on regulatory requirements (for instance, “achieve at least 20% renewable energy sources by 2020”), management mandate (for instance, “I want us to lower our carbon footprint by 20% by 2020”), or budgetary concerns (for instance, “your energy budget will be reduced by 10% per year on an intensity basis, so plan accordingly”). Existing goals may be viewed or edited in dashboard 200, and new or changed goals, once committed by a user in dashboard 200, are passed to data management infrastructure 220 (which is where EPM database 122, among things, is housed). According to preferred embodiment of the invention, goal setting module 202 is populated with data from a plurality of regulatory agencies, compliance standards (whether enterprise internal standards, industry standards, semi-official public standards, or legal standards), geographic information systems (for example, for managing geographically sensitive reporting or compliance standards and providing updated mapping data for map-based user interface elements), as well as other potential public data sources.

In some embodiments of the invention, a community module 204 is provided, to act as a repository for information on best practices, energy and GHG ratings of various devices (including consumer electric devices), and templates for use by members of an enterprise's extended community to participate in energy performance management. Community module 204 can act as a data source for analysis and planning module 201, but it can also act as an information dissemination vehicle to allow managers of an enterprise's energy and environmental initiatives to inform the public of their efforts and to enlist the support and assistance of the public and potentially of an enterprise's larger employee and partner communities. For example, an enterprise may desire to carry out an initiative of reducing the energy and GHG footprint of its employees that is due to their commuting to work, through a combination of actions that may in some cases require willing cooperation by those employees (for instance, by carpooling and keeping track of the gains thus resulting).

According to a preferred embodiment of the invention, analysis and planning module 201 is a user interface element within dashboard 200 (or within any end user browser 130; in some embodiments dashboard 200 only provides summary information and separate web-based interfaces enable functions such as analysis and planning 201). Analysis and planning module 201 is in effect a user interface to the user-interactive elements of data aggregation and reporting service 121 and initiative generation, modeling, and analysis services 123, although some aspects of the latter are optionally carried out in impact assessment module 205. Impact assessment module 205 and analysis and planning module 201 are exemplary of one mode of dividing up necessary functions of an initiative-oriented, portfolio-capable EPM system; it should be understood by those having ordinary skill in the art that other means of breaking down the logical functions into user interface modules is possible without departing from what is claimed. Similarly, track execution module 203 provides a user interface to initiative monitoring and reporting service 124. Track execution module 203 also provides an interface for managing and submitting required compliance reports, such as EPA's mandatory reporting requirements (MRR).

In some embodiments, core functions of an energy performance management system are integrated with third-party energy or carbon trading platforms; in these embodiments, dashboard 200 may also provide a trading module 206 to allow enterprise end users to set goals 202, interact with their energy and environmental community 204, analyze and plan 201, assess impact of proposed initiatives 205, track execution of selected initiatives 203, and conduct energy or resource trading 206 within one holistic end user interface paradigm. All of these end user modules interact with a model library 210, which contains models of existing, past, and potential future initiatives, models of energy use throughout the enterprise, and models of expected future behavior of extrinsic variables such as energy prices, regulatory changes, and so forth. In a preferred embodiment of the invention, models (and custom formulas, which in effect are models for how to calculate energy-related quantities) are accessible through various common user interface conventions such as pull-down lists, directory tools (where models can be browsed according to their logical hierarchical arrangement), and search tools (where search terms including wildcards can be entered to find relevant models).

Not shown in FIG. 2 but implicitly present in embodiments of the invention are various configuration interfaces used to maintain information related to the enterprise (these functions can be, but need not be, present in some or all of the previously described functional user interface elements). For example, a configuration tool for managing organizational models is provided, to allow users to enter information pertaining to the organizational structure of the enterprise. Similarly, geographic information (in addition to that provided from public sources) may be needed, such as identifying which facilities are assigned to which organizational and which regulatory regions (for example, when a user pulls a report on compliance with a western regional initiative, the report generator must “know” which facilities, and which employees, are “assigned to”, or present in, the applicable region). Also, extensive data on products that use energy, and on materials that are used in manufacturing or other processes within an enterprise, must be maintained. All such data, as well as the direct EPM data elements already described, are maintained in data management infrastructure 220. In addition to configuration interfaces, some of this data may come from legacy systems 230, from enterprise resource planning systems 231, or from operational systems 232 (such as a data center power management system). Data management infrastructure 220 also stores rules that are used in evaluating energy and environmental decisions, such as sourcing rules (for example, how much of electricity consumed must come from renewables, or from an in-state source, and so forth), utility billing data, and data on smart grids.

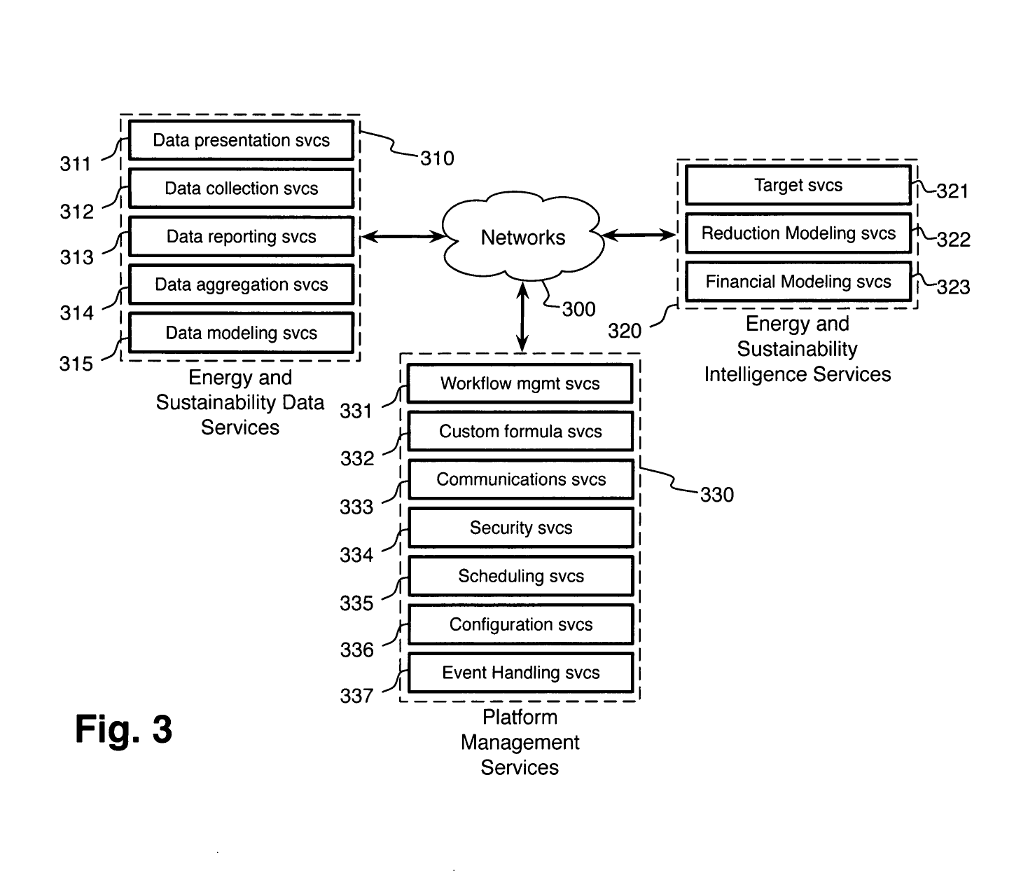

FIG. 3 shows a preferred embodiment of then invention in more detail. The embodiment consists of a plurality of services that, taken together, comprise an energy performance management system capable of carrying out the objectives stated above. Here, and throughout this application, the term “services” has a very broad but specific technical meaning. “Services” means data processing services made available over a plurality of networks 300 to a plurality of consumers; services may use other services, or services may be accessed by an end user via a web browser or a dedicated application that invokes services over a network. Services generally are often referred to as “web services”, although not all services need to be exposed via the World Wide Web; services can be “exposed” (made accessible to consumers) across any network or even within a single machine—a process on a single machine may invoke services provided by another process on the same machine in the same way as it may invoke services provided by another process on another machine across one or more networks 300.

The services illustrated in FIG. 3 are grouped, according to the embodiment, into three logical groupings to illustrate their relationships within an enterprise energy and sustainability performance management system of the invention. One group of services provides energy and sustainability data services 310, another provides energy and sustainability intelligence services 320, and a third provides platform management services 330. Broadly, data services 310 provide functionality needed for an energy performance management system to access, normalize, and manipulate data from a wide variety of sources (energy management resources, supplier data, financial data, environmental data, and so forth), while intelligence services 320 provide functionality needed to create, evaluate, and execute decisions needed to manage an enterprise's energy and sustainability initiatives, and platform management services 330 provide services commonly associated with large-scale, networked platforms. The grouping of services into these three groups is exemplary, and is intended to highlight the broadest functional aspects of the invention, which in the embodiment provides a cloud-based, platform-as-a-service (PaaS) platform (platform management services 330), that allows enterprises to build a complete understanding of their energy and environmental footprint (energy and sustainability data services 310), and to effectively develop, analyze, and deploy a portfolio of initiatives to achieve enterprise-wide energy and sustainability abatement and improvement goals (energy and sustainability intelligence services 320).

Data presentation services 311 provide a variety of services that enable human users to view energy-related data in ways that facilitate understanding. Enterprises will in general have a very large number of energy resources, arranged in quite complex hierarchies along, for example, geographic, organizational, temporal, energy type, and functional dimensions. Because understanding such a large amount of complex data and the relationships between different data elements is challenging for users, a variety of presentation styles is generally needed. For example, geographical data may be presented in tabular format with a folder-style hierarchical representation in some interfaces, but as a clickable map in another. In another example, when evaluating a portfolio of energy initiatives, users may be presented with a marginal abatement cost chart, which is a graph that shows the marginal cost and abatement impact of a variety of initiatives within a portfolio. There are many other ways where the complex data inherently contained within an energy performance management system can be presented to users, and the preparation and delivery of these various visualizations is carried out by data presentation services 311. Data collection services 312 correspond to the various activities discussed in detail above with reference to data collection service 120. According to one embodiment, data collection services 312 includes an invoice collection service which is configurable to receive invoice data from a plurality of suppliers via batch uploads (using Secure File Transfer Protocol SFTP), either based on a schedule or manually triggered, and including provision for automated receipt of invoices from suppliers going forward. Invoices can be retrieved as Excel spreadsheets, comma-separated-values files, plain text files, electronic data interchange (EDI), or via a more modern web service using XML-derived formats. It should be appreciated by one having ordinary skill in the art of data transfer that there are many ways of transferring data, of which these are only an example. Similarly, data aggregation and reporting service 121 is broken down, in the exemplary embodiment illustrated in FIG. 3, into three elements, namely data reporting services 313, data aggregation services 314, and data modeling services 315 These three elements also carry out the functions of initiative monitoring and reporting service 124, thus illustrating the wide variety of architectures and logical distributions of functions that may be present in various embodiments of the invention. The invention is about a new approach to enterprise-scale, computer-mediated energy performance management and thus discloses a considerable number of related and needed functions, but it is not about any precise architectural arrangement of those functions. Among other functions, data modeling services 315 provides means for normalizing energy and sustainability data across an enterprise. Of course, normalization may be carried out in quite different ways for different purposes within an enterprise, which is one of the reasons enterprise energy performance management is very complex. For example, a given resource might be an energy consumption point, say a backup diesel generator at a medical facility. The raw data it generates is typically energy generated per unit time, and supporting data such as fuel consumed, energy quality (how tightly regulated was the voltage, for instance), and a large amount of data concerning the operation of the generator (for instance, oil pressures, cylinder temperatures, and the like). Clearly not all of these data elements are going to be used in energy performance management (some will be used only by those who maintain the engines), but at a minimum the energy generated per unit time would be relevant. This data would need to be normalized by the use of an emissions factor to determine the greenhouse gas (GHG) emissions associated with the energy generated. What complicates things is that different emissions factors may be specified by different “users”; a regulatory agency might specify that a particular emissions factor be used for diesel generators generally, whereas another might specify different emissions factors for different types of diesel generators and different fuel types. Some might include only the effect of CO₂ generation in setting an emissions factor, while another might include all GHG emissions associated with running a diesel generator (for instance, CO, SO₂, NO_{N}, and even H₂O are likely to be present in diesel exhausts, and all of them are GHGs). Also, some regulators might specify different emissions factors for biodiesel, and they might also classify biodiesel as a renewable energy source (in which case the same energy activity—running the diesel—would be creating negative value by emitting GHGs but also generating positive value by raising the percentage of energy from renewables for the enterprise, which might result in public relations, regulatory, or even financial benefits to the enterprise). In general, custom formula libraries and formula editors, as described herein, are carried out by data modeling services 315.

Energy and sustainability intelligence services correspond, broadly, to initiative generation, modeling, and analysis services 123. Target services 321 provide for the specification of strategies and targets (where “targets” refers to goals to be achieved, generally for the mitigation of energy and environmental impacts resulting from an enterprise's business activities), and for the management of initiatives designed to meet those targets. For example, target services 321 can display a current status of all open or active initiatives within an enterprise, or a portion of an enterprise for which a particular user is responsible, and can show whether time-based mitigation targets associated with the initiative are being achieved. Where targets are not being achieved, or at least not within some established compliance threshold, target services 321 may automatically generate one or more recommendations to the user. Reduction modeling services 322 and financial modeling services 323 (which could, in some embodiments, be combined into a single “modeling services” element), allow users to model a variety of possible initiatives to achieve some target. For example, a user could be focused on meeting a target of “increase renewables percentage for scope 1 and 2 sources associated with your facility to 20% within 3 years”. As the user considers this target, she may start by obtaining recommendations from the system based on industry benchmarks, or on similar targets that were pursued elsewhere, or previous experiences within her own enterprise. In some embodiments of the invention, libraries of project or initiative templates are maintained for just this purpose. For example, if the user is part of team planning a new data center, and the user in particular is responsible for sustainability (meaning optimizing energy and environmental impacts of the data center), she may pull templates for local thermal storage, virtualization of machines, advanced control systems such as motion sensors to control lights throughout the facility, and so forth. Each of these templates will contain information useful for evaluating the templated initiative, and will include data on typical costs, likely quantitative impact, and timing constraints. For instance, if a data center sustainability manager were to review a “use solar collectors and local thermal storage” initiative, she would be presented with up to date information on the costs of various types of solar installations, the implementation process and associated times to implement each phase of it, and data about different types of local thermal storage and the performance of each. Note that templates can be provided via target services, according to the invention, from suppliers (as when utilities provide guidance on how to conserve, or how to participate in demand response programs profitably, or when a provider of solar cells provides a template for the initiative just described, to help prospective clients choose and deploy solar successfully), from governmental agencies, from previous work at the same enterprise (typically, initiatives are archived and energy performance managers select particular completed initiatives to use as templates for others to use in the future), or from third parties such as consultants or vendors selling templates directly for use in energy performance management systems of the invention.

Clearly, starting with such a template greatly facilitates the process of building portfolios of initiatives designed to achieve energy performance management targets. But the real world problems faced by energy managers will be unlikely to be addressed exactly in a pre-built template. Accordingly, reduction modeling services 322 and financial modeling services 323 allow users to take a new initiative (either from a template or created from scratch using target services 321), and model its likely costs, implementation process, and future impact accurately. Generally, many variables concerning both the present and the future will need to modified, and in the case of forecasts it will typically be necessary to run a range of forecasts and then to simulate outcomes under various scenarios to understand the likely costs and benefits of executing the initiative. To take the solar-for-data-center example discussed in the previous paragraph, the costs of implementing solar and internal thermal storage that were contained in the template need to be adjusted based on current local market conditions. Similarly, any such project's economic viability will be tied closely to the future costs of substitutes; that is, the future price of utility-based and other sources of electricity that could substitute for power generated by the solar power system will be a key factor in the future value of the solar power system. Generally, large facilities such as data centers pay variable rates for electricity, so the local demand-based price curve for power needs to be an input. Additionally, regulatory factors are likely to be important; for instance, some states require certain percentages of renewables by a certain date for enterprises above some size, and impose penalties on those who don't comply. In determining whether an economic benefit will be received by an enterprise for deploying solar-and-internal-thermal-storage at the new data center, many variables will need to be modeled (e.g., “How much will the use of solar move the needle on renewables?”, “How big are the penalties?”, “Do we meet, or will we meet, the minimum size standard in the foreseeable future?” and so forth). Additionally, local weather patterns and expected temporal patterns of energy usage will need to be considered (for instance, “How often, and for how long, does the sun shine at the data center location?”, “How much energy can be stored during the sunlight to be used at night?”, and “When are the peak data center power consumption periods and can we control them by modifying processes within the data center?”). It should be clear from these examples that evaluating any given initiative is challenging and complex. In the solar data center example, outcomes could vary widely; the difference between one situation where peak data center power consumption coincides with peak ambient solar and also local peak demand-based prices, and one where the peak data center power consumption occurs in evening hours when both the sun and the demand-based electricity prices are down, is clearly going to be extremely large. Accordingly, reduction modeling services 322 and financial modeling services 323 allow the analyst to explore a wide variety of “what if?” scenarios to build a model of each initiative that build various best case, most likely, and worst case models, and to assemble a group of initiatives into a portfolio. Additionally, portfolio-level modeling and analysis tools are provided, such as providing, in one embodiment, a marginal mitigation cost curve showing a variety of scenarios so that users can build, test, and ultimately select and deploy a portfolio of initiatives that will meet the targets set at acceptable risk levels.

Because of the scale and complexity of enterprise energy performance management, a preferred embodiment of the invention is deployed as a Platform-as-a-Service (PaaS), which is a combination of Infrastructure-as-a-Service and Software-as-a-Service, in that all of the necessary infrastructure required to carry out the many functions of energy performance management, and the applications required for the same, are provided by a single set of network-accessible services as shown in FIG. 3. The third major grouping of services pertains to the platform nature of the overall service, providing a series of services normally associated, in single-machine platforms, with a machine's operating system and associated “always on” software applications that provide services to all corners, without being designed for, or tied to, particular applications or application types. For example, workflow management services 331 make workflow management functions available as needed to support particular energy management functions. Workflow management systems in general are not designed around particular subject matter or application domains (on the other hand, the work flows that they manage generally are deeply tied to specific subject matter or application domains). Functions provided by workflow management services 331 include all of the functions typically associated with business process management systems, which are well established in the art. Custom formula services 332 provide interfaces for adding, editing, or using custom formulas. Formulas are maintained in a library from which a user can choose, or a user can create a new formula which, once created, becomes part of the library. According to the invention, formulas can be built using user-defined variables as well as predefined variables. Communications services 333 provide a variety of services that allow users and services to communicate with each other, either synchronously or asynchronously, and either on a scheduled basis or an ad hoc basis. Examples of communications services provided in embodiments of the invention include, but are not limited to, notification services, email services, instant messaging services, social media integration services (for example, a service that allows an alert to be sent via Twitter™), file transfer protocol services (FTP or SFTP), and the like. Security services 334 comprise various methods for ensuring data integrity, communications integrity, and user access controls. Examples include authentication services, encryptions services, audit trail services, and the like. Scheduling services 335 comprise a variety of services intended to allow for time-based activities, such as scheduled notifications, scheduled threshold checks, periodic updating of financial performance of initiatives, and the like. Configuration services 336 provide a rich set of interfaces for managing the configuration of the energy management system and of the actual energy resources it manages. Examples of configuration services include a user account configuration service, an organizational configuration service for configuring company, business unit, and facility data, a geographical configuration service, a service for managing business relationships such as partnerships, reseller relationships, supplier relationships, and the like. Finally, event handling services 337 provide common event-related services such as allowing other services or users to publish events and to subscribe for events, to distribute each incoming event with a unique event identifier to all appropriate subscribers, logging events as they occur, and so forth.

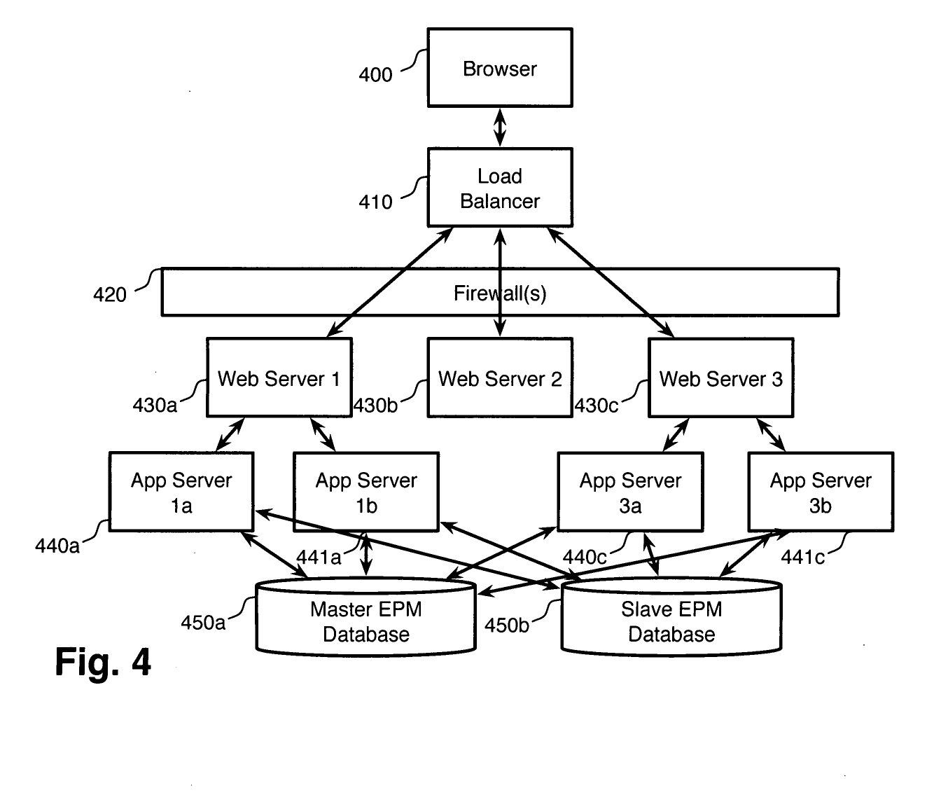

FIG. 4 shows an exemplary network for an energy performance management system deployed in a cloud, or network-resident, architecture. As before, end user interactions take place via a browser 400, which interacts initially (not taking into account items such as domain name servers that are used by all browsers) with load balancer 410, which acts to send requests from browsers 400 to one of web servers 1 through 3 430a-c (there can, of course, be any number of web servers without departing from the invention; the illustration of 3 is merely a matter of convenience), based on loading conditions at a particular moment at each of the web servers 430a-c. The provision of load balancing 410 upstream of web servers 430a-c is fairly well-established in the art, and is available from all cloud infrastructure providers. In some cases, requests from browsers 400 will be made to pass through one or more firewalls 420, which can be specifically used for only one enterprise, or which could be a hosted firewall of a cloud platform provider. Again, use of firewalls is well-established in the art of network security, and many variations are possible. Web servers 430a-c receive requests from browser 400 and pass them to appropriate application servers 440a-c and 441a-c. In a preferred embodiment, because the stateless REST architecture constraints are observed, each request can be transmitted to any application server 440, 441 that provides the requested service, without regard to where any previous request from browser 400 was sent. In some alternative architectures, a more connection-oriented approach might be required, if a more state-aware approach is used for the requests. As is standard in the art of advanced web application design, not all application servers will host all services, and as load conditions demand many new instances of a highly-utilized web service may be added without reconfiguration (as long as load balancer 410 is aware of changes in service locations), and equally easily less-demanded services can offloaded from some application servers 440 to enable more instances of more in-demand services to be loaded. The use of a stateless, REST-compliant architecture and the leveraging of advanced cloud infrastructure such as the Amazon Elastic Cloud means that an energy performance management system can scale rapidly as needed (for instance, if a major regulatory change required massive analysis of existing and planned initiatives to determine compliance and to identify areas to focus on in order to meet the new regulations.

While application servers can be added or dropped dynamically, in a preferred embodiment data management infrastructure 220 is implemented as a cloud-resident master/slave architecture. A master EPM database 450a is hosted in one data center of a cloud provider, and a slave EPM database 450b is hosted in a different data center belonging either to the same cloud provider or, if desired, in a different cloud provider's data center. Usually, a master EPM database 450a and its slave EPM database 450b are provisioned using well-separated network infrastructure and geographical dispersion, so that natural disasters are unlikely to knock both out of action simultaneously. Of course, while it complicates data replication, additional EPM database instances could be used, and a master/slave arrangement is not the only possible one that can be used in accordance with the invention.

In a preferred embodiment, an exemplary architecture such as is illustrated in FIG. 4 is operated as a Software-as-a-Service (SaaS) offering, with multiple enterprises' being served by a single operator of enterprise performance management systems. In some such embodiments, separate sets of application servers 440, 441 are provided for each large enterprise client (and, if extremely strong separation is desired, even web servers 430 and firewalls 420 can be separately provisioned for each enterprise client. In other embodiments, a multitenant approach is used, and a single application server 440, 441 can be used to service requests for multiple enterprises. In such cases, additional safeguards are taken in application servers 440, 441 and EPM databases 450 to ensure that each enterprise is only able to retrieve, view, act on, or change its own data and not that of other enterprises. It should be appreciated by one having ordinary skill in the art of cloud-based SaaS systems that there are several ways to accomplish this, any one of which can be used according to the invention.

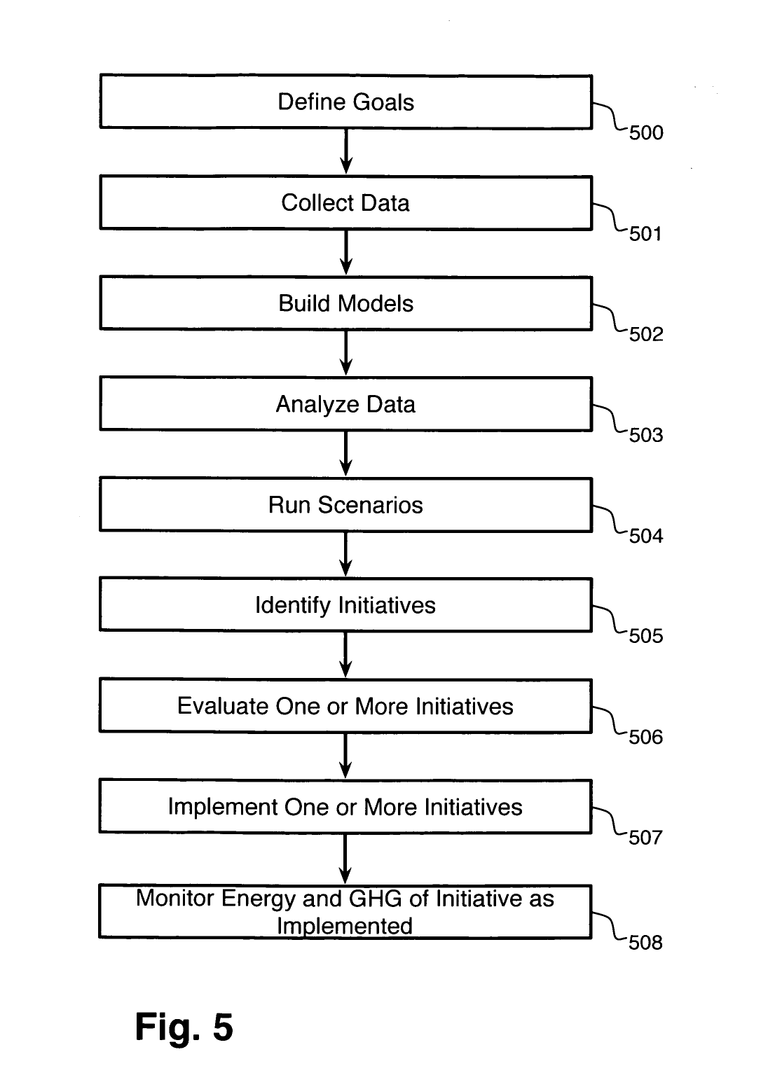

FIG. 5 provides a process flow diagram of an exemplary embodiment of the invention. In a first step 500, users within an enterprise define goals to be pursued within the enterprise's energy and environmental planning function. Goals may be simple and economic, as mentioned before (for example, to reduce overall energy costs by 5% per year for the next several years in pursuit of overall profitability), they may be driven exclusively by regulations (for instance, to meet mandatory reporting requirements from EPA, or to meet mandatory renewable content levels for one or more states), they may be competitive in nature (achieve superior competitive positioning in a green-leaning market by “out-greening” the competition), or they may be qualitative (reduce reliance on coal in the face of increasing competition for existing supplies, said competition coming largely from China and India). Indeed, goals may be driven by any combination of these, or by other needs perceived by an enterprise. As with motives, the form of goals may be quite varied as well. In some cases, a goal may be simple to state and to measure: reduce electrical consumption per unit of revenue by 5% across the enterprise, or lower the energy spend by 5% each year in absolute terms. In other cases, goals may be more qualitative, and potentially difficult to measure: work to buy more power from non-conventional sources (requires identification of what “non-conventional” means, and it's often difficult to measure where electrical power came from absent an auditable abstraction layer such as renewable energy credits). In preferred embodiments of the invention, goals can be entered (even if in free text form) directly into an energy performance management (EPM) system, and used to drive all of the steps that follow in FIG. 5.

After, or in parallel with goal definition, data is collected in step 501 pertaining to energy usage and environmental impact resulting from an enterprise's activities (not necessarily only in terms of energy consumption; the inventors foresee using an EPM according to the invention for managing initiatives relating to other resource usage or environmental impacts within an enterprise). As discussed above, said data can be both real-time usage and emissions data, as well as periodically batch-loaded data (such as nightly uploads from a utility's billing system, or 15 minute uploads from Google Power Meter of all or some of an enterprise's energy usage data). Also, in many cases a bulk upload of historical data, for instance of past utility bills and past compliance reporting to environmental regulators, are obtained in this step. The goal of step 501 is to collect as much data as possible (and to keep collecting data so that a running accurate picture is developed. Since it is important to the effectiveness of enterprise EPM that as much of an enterprise's energy and environmental footprint as possible is measured and optimized, it is important in step 501 to get as much coverage as possible. This includes coverage of all types of energy usage (for instance, a visionary green-leaning enterprise might endeavor to gather data on employee commute habits and use that to help drive additional societal—and potentially PR—benefits for those employees and the enterprise; participation by employees in measurement and optimization activities could be encouraged with enterprise-funded incentives to employees). It also includes coverage that is as granular as possible (one of the biggest opportunities in energy performance management is simply to manage energy in smaller increments of time and space, particularly when demand-based pricing makes the economic impact of highly granular measurement quite high), both in terms of spatial granularity (down to the meter or device level), and time granularity (in principle, an enterprise ought to be able to achieve minute-by-minute measurement and reaction to energy changes, although very few are even close to this today).

Following initiation of a comprehensive energy data collection program, in step 502 detailed models of an enterprise's current energy usage and environmental footprint is built. These models are necessary, even before focusing on improvement initiatives, for an enterprise to be able to understand its energy and environmental footprint overall and in each region (and business unit), but also be able to meet increasingly stringent, varied, and urgent regulatory reporting requirements. One aspect of building models in step 502 is the building of a library of custom formulas for computing many of the quite complex environmental and energy parameters in use today. While in many cases software systems endeavor to provide all standard formulas for a business activity out of the box, in the area of energy and environmental compliance and remediation this is made difficult by the fact that many governmental, quasi-governmental, industry-level, and public interest-based groups issue standards that require or urge management or measurement of the same thing in quite different ways. Since many of these entities enjoy considerable legal power over enterprises, and can therefore simply mandate that a certain parameter be measured and reported in a certain way, it is important during the model building step 502 that a library of custom formulas can be built up. Another important part of the model-building step 502 is the development of a library of forecasts of oil prices for the next two decades based on a variety of underlying assumptions. The inventors note that an EPM system according to the invention can combine locally specified or generated models and models developed by interested third parties (again, governmental or quasi-governmental, industry-specific, or even for-profit analysis firms such as those that specialize in forecasting oil price developments).

Once a robust model library is in place, data is analyzed in step 503 to develop an understanding of an enterprise's generally quite complex energy and environmental footprint (more accurately, an enterprise should be thought of as having many footprints, many of which may seem out of step with an enterprise's officially stated path forward!). Data analysis step 503 is conducted with models from step 502 firmly in hand, so that different aspects of the enterprise's activities can be compared to regulatory models, in effect performing energy and environmental triage.

As analysis progresses, in step 504 scenarios are run to determine how the enterprise “as is” is likely to develop from an energy and environmental perspective in the absence of any new initiatives. For example, models of unlikely external events could be run to determine if an enterprise's existing structure is robust against, for example, a massive disruption in oil supplies. Similarly, existing operations can be tested against various forecast scenarios for future prices and availabilities of energy commodities such as oil, natural gas, biofuels, etc. Often such scenarios will provide stark illustration of an enterprise's vulnerability to disruptions that are not at all unlikely to occur; since EPM systems have not been in existence in the art until the instant invention, enterprises have in essence been “flying blind” in terms of their dependence on vulnerable energy supplies or of the existence of easy and economically beneficial steps they could have already taken which would drastically reduce their carbon footprints. When one considers that it is only recently that governments have begun to look at the energy and environmental situations as one complex system perhaps running amok, it is unsurprising that enterprises are in general ill-informed and unprepared. The scenario testing step 504 is thus an important step in developing enterprise-wide awareness of the “as is” state, and to create motivation for defining and approaching a desirable future state that is economically, legally, and politically suitable.

A key step in energy performance management is to define initiatives in step 505. Generally, prior analysis and scenario testing will have revealed numerous areas where improvement is needed, and generally suffice to generate a substantial potential initiative list. In preferred embodiments of an EPM system according to the invention, candidate initiatives can be easily entered by various users within an enterprise (and in principle, from without the enterprise as well; enterprises could invite public suggestions for energy or environmental initiatives they would like the enterprise to consider, or they could come as suggestions from regulators or even packages of templated initiatives provided by third party entities). Once at least a plurality of initiatives has been entered into the EPM system, in step 506 one or more enterprise staff members (or for example a consultant) analyses a plurality of initiatives. As discussed above, there are many ways initiatives can be analyzed, including scenario testing, overall impact forecasts using various parameter forecasts from a forecast library, testing with unlikely but possible events, and other forms of analysis derived from conventional investment analysis. A further improvement of EPM systems according to the invention is the provision for grouping initiatives into portfolios, which can be analyzed in much the same way that asset portfolios are analyzed by investment professionals. In particular, by analyzing various asset (initiative) combinations treated as portfolios, it will in general be possible to identify optimal portfolios that maximize return within acceptable risk levels, and which often have lower risk taken as a portfolio than the individual assets (initiatives) do on their own. In financial investing, this overall risk reduction by matching assets with poorly or negatively correlated returns or risk factors is well understood, but it has not been possible to carry out such analyses in the art of energy and environmental planning in enterprises because of the absence heretofore of EPM systems according to the invention.

Once a suitable portfolio, or initiative, or a plurality of either, is selected in step 506, the initiatives are implemented in step 507, and then in step 508 energy and environmental impacts of the initiatives are monitored. One goal of the monitoring is to compare actual results obtained against those predicted in step 506 so that underperforming initiatives can be corrected or, if incorrigible, stopped and replaced with more fruitful initiatives. It can be seen that the method of FIG. 5 provides a novel means of understanding and optimally managing a complex enterprise's energy and environmental impact in a way that improves economic performance of the enterprise even in the face of a rapidly shifting energy economy and environmental regulatory climate.

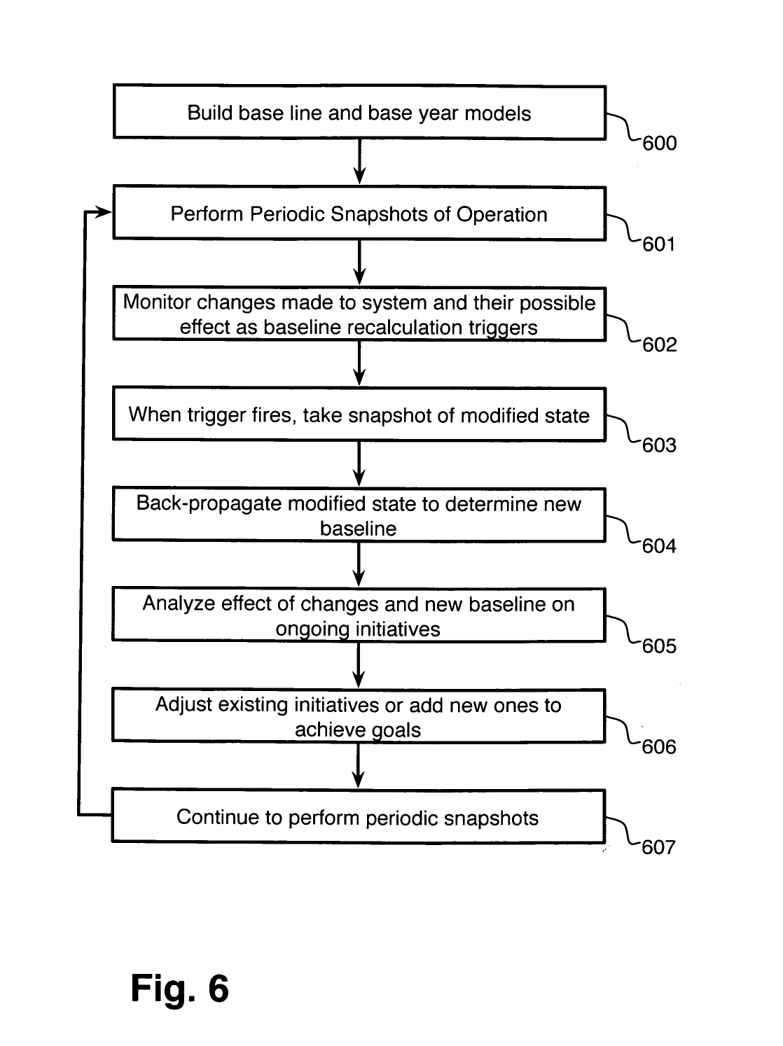

FIG. 6 provides a process flow diagram of a method according to the invention for the dynamic recalculation of baselines used for regulatory reporting within an enterprise. In initial step 600, baseline and base year models are developed. Often more than one is needed in an enterprise, as there are often multiple different regulatory reporting requirements that specify different baseline years or different methods of calculation. In general, the purpose of a baseline is to provide a standard “run rate” against which future “run rates” can be measured (these are very useful for intensity-based measurements and goals). Base years are generally calculated in order to support reporting of progress against goals such as “By 2012 GHG emissions for enterprises of a certain type will be reduced by 20% from their 2005 base year level”.

A challenge for baseline and base year-driven reports and initiatives is that enterprises are not static entities. Quite often enterprises divest themselves of underperforming assets and acquire other companies for strategic purposes. Often particular functions or facilities are outsourced or even sent offshore in search of lower costs or more enterprise focus on core competencies. Old plants are sometimes converted to new uses or sold off. Product lines change, and the mix of materials that go into producing them often change. Because of these challenges, regulatory reporting requirements generally require a recalculation of applicable baselines or base years when certain threshold conditions have been met. The process described with reference to FIG. 6 is intended to address this problem within the context of energy performance management (EPM) systems according to the invention. In addition, the need for carefully managing baseline and base year recalculations is made even greater by the fact that initiatives, to be properly understood, modeled and analyzed, must be capable of being meaningfully measured across time boundaries during which baselines or base years were recalculated.

In an effort to address these challenges, the inventors have conceived an automated baseline recalculation system that leverages periodic and ad hoc snapshots to enable robust backward and forward propagation in time as required to satisfy regulatory reporting requirements and to accurately model and understand performance of energy and environmental initiative portfolios in rapidly changing enterprise environments.

In step 601, periodic snapshots are performed of an operation, whether it is an entire enterprise or some subset thereof (indeed, the process outlined in FIG. 6 could be carried out across enterprise boundaries as well, for instance if an industry consortium wanted to coordinate energy actions on behalf of a whole industry for political, legal, or public relations purposes. The snapshots taken in step 601 are normally complete images of EPM database 122, which means that all rules, organizational structures, historical energy usage data, and even existing forecasts are saved as is for use in future recalculations. In addition, in step 601 ad hoc snapshots of all or a part of an enterprise may be taken when desired; the only limitation is storage space. In step 602, all changes to an enterprise's structure or energy usage are monitored and evaluated against their possibly satisfying conditions to act as a trigger for a baseline or base year recalculation. Triggers for recalculation are often specified in detail by one or more regulatory or monitoring bodies, but they can also be set up as “house rules”, that is rules internal to an enterprise, when desired. Note that most large enterprises operate across more than one regulatory jurisdiction, and in the case of global companies across many, so in general it is likely that in EPM systems according to the invention, many independent recalculation trigger rules will be required. In addition, it may be desirable from an enterprise management point of view to define internal triggers that are more easily fired as part of an overall initiative portfolio management strategy, so that portfolios can be assessed most accurately in terms of actual performance against intended performance, without intervening noise caused by many small changes that may not rise to the level of firing a regulatory recalculation trigger. Additionally, because different rules may fire at different times for different subsets of an enterprise, there are according to the invention any number of “active baselines” within an enterprise. The key of course becomes using the right baseline for any given purpose. For example, it may be for a global company that a Europe-wide base year of 2006 was recalculated in late 2010 because an acquisition in Europe, and that a 2009 global baseline was recalculated again in mid-2011 because of a corporate-wide commitment to achieve certain targets that are calculated in a novel (presumably more meaningful) way. Now, when evaluating performance of an initiative spanning Europe and North America that was started in late 2009, it will be necessary to apply different adjustments for each data element depending on what time period and geographical region it applies to. The importance of having complete snapshots and a robust library of models within an EPM system according to the invention is clearly evident.

In step 603, when a trigger fires, an immediate snapshot is taken of the enterprise (or affected portions thereof; snapshots need not be total but can be managed at an object level) at the time of triggering. Then, in step 604, the modified post-trigger state is back-propagated in time to the applicable base year or baseline time (note there could be more than one of each of these, for the reasons described in the details concerning step 602). Back-propagation can be conducted in many ways, according to the invention; for example, if an entity was acquired to fire a trigger, then historical usage data from that organization (if available) can be incorporated into the historical data for the pore-acquisition enterprise to create a sense of what the baseline would have looked like had the now-combined enterprise been combine prior to the baseline time or base year. In an alternative exemplary embodiment, where for example an acquired entity had not tracked the relevant data during the relevant pre-acquisition period, a model of the acquired company can be built by using data from comparable portions of the acquiring company to build an estimate of what the current footprint of the acquired company is (and this estimate can be refined as measurements begin to be taken post-acquisition, to reduce errors intrinsic in this data-censored approach), and then this model for the current state of the acquired company can be back-propagated by applying retroactively the measured growth rates and price moves experienced by the acquiring company.

In step 605, ongoing initiatives are analyzed in view of the new baselines, base years, and organizational structure, both to update their targets and measurements to reflect the new enterprise structure, but also to determine if the initiative still makes economic sense in light of the new information. For example, an initiative focused on growing renewables percentage in an enterprise might become obsolete it the enterprise acquires an entity built entirely with renewables that pushed them over the target level immediately (of course, the initiative might be sustained in order to pursue continuous improvement, but this would depend on the “real” economic value of renewables at the time—if they were being pursued only to meet an expensive but necessary regulatory minimum, there would no reason to outperform).

Based on the results of step 605, in step 606 new initiatives are created or existing initiatives are modified, or both. In an enterprise performance management process, of course, new initiatives are likely to continually be under evaluation at all times, and existing initiatives are continuously being reconsidered based on their performance and possibly on extrinsic factors or external events, but clearly recalculations of baselines will always represent good opportunities to evaluate existing initiatives and consider new ones. Finally, following step 606, the creation of periodic snapshots resumes as before in step 607, and the process in essence is recurrent, resuming at step 601.

FIG. 7 provides an illustration of exemplary process flows according to a preferred embodiment of the invention. For reasons described in detail above, including diversity of geographies, energy sources, regulatory requirements, and organizational structures and relationships, energy performance management is an extremely complex business. FIG. 7 is an effort to show the invention makes it possible for enterprises to realistically handle the many permutations, by showing how even a subset of available interconnections enable very rich work flows to be carried out according to the invention. The approach will be first to enumerate the elements of the figure, and then to describe exemplary work and data flows that more fully illustrate embodiments of the invention.

A set of basic data tasks 700 includes establishing an inventory of energy and sustainability resources 701, collecting data from those resources 702, collecting data from suppliers (and partners) 703, and collecting data from markets 704. When an inventory of resources is established 701, optionally baselines and base years are also calculated (sometimes these are calculated for a previous time period by back-propagating current inventory data, as described above). Once an inventory of resources is established 701, it can be periodically audited 720, either manually or automatically, to ensure that any inventories within an energy performance management system of the invention correspond to the actual real-world resources they represent. Data collected 700 is passed to data preparation steps 710, comprising for example the steps of normalizing data 711 and for aggregating data 712. Normalization and aggregation have been discussed previously, and serve to take raw data from data collection steps 700 and put it into various forms that are suitable for use in later process steps.

One of these later process steps is interaction with the data for purposes of analysis and decision-making 730. A key function is that of reporting on the data 731, which allows users to view data about historical trends, current states, and to compare them to industry or regulatory benchmarks or internal goals (internal goals, and strategies for achieving them, are input 740 at various times, and serve to act as the normative standards against which prospective plans are tested and the effectiveness of implemented plans and activities is measured). Another key process step is checking for thresholds 732. Thresholds are a capability of systems according to the invention that test one or more variables against a target threshold and, if the test shows that the variable met the threshold, firing an event that can be handled by downstream processes. As an example, if a target entered in step 740 is to reduce energy intensity (energy consumed per unit of economic output) in 2011 by 10% over what it was in 2010, then an energy performance manager might set a threshold of 1% per month for overall energy usage reduction. Then, when monthly energy date has been collected and aggregated, if the total energy consumption intensity is not at least 1% lower than the previous month's value, the threshold would be met (by convention, one normally speaks of exceeding thresholds, so the threshold would be expressed as “achieve less than 1% reduction in energy intensity for a given month”, which would be met in any month where the energy intensity reduction was less than 1%). Once a threshold is met and an event is fired, what happens as a result is determined by downstream process steps that process threshold events, some of which will be described here as examples. Another step commonly carried out is comparing data to benchmarks 733. The inventors envision that not only will well-established regulatory benchmarks be made available to users of the system, but also benchmarks set by industry or by facility type (for example, data centers may use a certain amount of energy per unit of “data work”, or steel mills may have an industry average renewables percentage), and benchmarks that are built up within the system over time as large numbers of enterprises' energy performance is measured with a level of granularity and breadth not achieved in one system before.

In a preferred embodiment of the invention, a key function of the system is to make recommendations 770. For example, if a threshold is exceeded, one way to “handle the event” is to evaluate the data contained in the event to determine if there exists, in a data store within the system, a recommended action that would tend to correct the deficiency identified by the threshold (note that thresholds do not necessarily measure only deficiencies; one could as easily receive an event stating that a desired reduction target has been exceeded by 10%, and this could lead to a recommendation to carry out more of the same type of initiative, either here or elsewhere, especially if the cost of the initiative ended up lower than expected). According to the embodiment, one form of recommendation generation entails evaluating a condition and then retrieving 750 one or more models from a library that are (at least as generically defined) able to ameliorate the problem described by the condition. The availability of a library of templates or “off the shelf” initiatives, each characterized by the benefits it is expected to generate, provides a recommendation engine with a valuable source of means to correct undesirable conditions, and overall this process provides a rich source of learning and adaptation for enterprise energy performance managers. Models can be retrieved or generated 750 by users manually, or automatically by another service within the energy performance management system, as when a recommendation engine retrieves a model from a library. In some cases, a user will browse a library of available models that are applicable for the general class of problems being considered by the user at the time (for example, “Give me a list of initiatives that might help me reduce energy usage at my retail facilities”). Then the user can retrieve one or more models found, or generate new models 750 (which can be available to later users). Once models are in hand, users can prepare forecasts 751 to determine how the model is likely to behave under conditions actually occurring for the user's enterprise (and also, under various configurable future conditions). Forecasts can be prepared 751 using a variety of forecast data elements, such as estimated future utility electricity prices, projected natural gas prices, likely regulatory shifts over the relevant time period, etc. Users can then proceed to assemble portfolios 752, or to modify existing portfolios. When assembling a portfolio, a user may decide to add more initiatives to the portfolio, which can be done by asking the system to make a recommendation 770 or by manually retrieving or creating addition models 750. Once a portfolio is created, it can evaluated by comparing it to benchmarks and optionally other portfolios in step 753. For instance, if a user has assembled a portfolio of ten energy conservation initiatives, she could compare it to energy conservation benchmarks from her industry, from other similarly sized enterprises, or from governmental recommendation benchmarks. She could also build more than one portfolio, perhaps one focusing on conservation and another on making investments in renewables, and then compare the two or more portfolios against each other 753. Comparisons can be made based on expected financial value, expected GHG mitigation success, expected renewables concentration, expected reductions in energy intensity, or any number of other similar target metrics. As a next step, a user (or an automated process) compares a selected best portfolio, potentially from among a set of portfolios, against established goals or targets to determine if the best portfolio is satisfactory 754. If not, then the user may decide to reiterate the process by modifying one or more portfolios 752, optionally comparing it against benchmarks 753, and then reassessing it against a standard 754. If the portfolio is deemed satisfactory in step 754, then the user may initiate implementation of initiatives in the portfolio 760. As initiatives are being implemented, and after implementation, their performance against their expected costs and benefits is periodically measured 761, and a decision can be made as to whether a portfolio needs adjustment 762 (that is, if the initiatives are not meeting expected targets, there may be a need to adjust the portfolio containing the initiatives, perhaps by adding more initiatives or by adding more weight to one of the existing initiatives). Again, if a portfolio is found wanting, the process can resume at step 752 again.

The process outlined very generally in FIG. 7 is illustrative of the rich behaviors that emerge under energy performance management systems according to the invention. In some cases, an enterprise executive or board may articulate a high-level goal (step 740), such as “We will reduce our GHG emissions intensity by 10% over the next three years”). If an energy performance management system were already in place, with accurate energy usage and emissions data and baselines in place (and potentially with some existing initiatives in progress), then those receiving this directive from management would proceed directly to reviewing current data in step 731 to determine how far off the enterprise is, on its current trajectory, from achieving the new target. Then, based on that analysis and possible threshold checks 732 (carried out after the energy managers entered the new thresholds corresponding to the new target), the energy performance management system may make one or more recommendations 770, and energy managers would process either to modify an existing portfolio 752 (to “beef it up” in order to make the more aggressive target), if any current portfolios exist, or to retrieve additional models 750, prepare forecasts 751, and then assemble a new portfolio 752. As another example, monthly energy usage measurements collected from suppliers 703 and resources 702 are normalized 711 and aggregated 712, and the aggregated data is checked against a monthly target threshold 732 and found to exceed the threshold (too much energy was used). Or, the same point might be reached because, while usage was “in bounds”, data from markets 704 showed that an alternative provider would have saved a significant amount of money, or achieved a higher renewables percentage, or reduced scope 2 emissions, or any combination of these and other possible comparisons. This market data could trigger a threshold such as “maximum delta between preferred renewable supplier and lowest cost non-renewable shall not exceed 10% in any given month”, and lead to the whole recommendation/modeling/forecasting/portfolio assembly/modification process. It should be clear that any number of process paths is possible according to the embodiment illustrated in FIG. 7, which is itself exemplary in nature. When comprehensive data collection, normalization, and aggregation is coupled to strong workflow tools, management decision support tools, and a portfolio model for handling energy initiatives are assembled into an integrated enterprise energy and sustainability management system according to the invention, enterprises will no longer need to “fly blind” while trying to balance environmental responsibility, business flexibility, and the bottom line.

All of the embodiments outlined in this disclosure are exemplary in nature and should not be construed as limitations of the invention except as claimed below.

What is claimed is:

1. A system for resource performance management, comprising:
a network-connected data collection service adapted to receive data from a plurality of resources;
a network-connected data aggregation and reporting service adapted to aggregate resource-related data on at least temporal, organizational, geographic, and resource-specific dimensions;
a network-connected initiative modeling service adapted to facilitate modeling by a user of a plurality of resource-related initiatives; and
a network-connected initiative monitoring service adapted to receive data from one of the data collection service and the data aggregation and reporting service, and further adapted to measure performance of a plurality of resource-based initiatives;
wherein a plurality of resource-based initiatives are assembled within the initiative modeling service into a plurality of initiative portfolios, and the plurality of initiative portfolios are modeled under a variety of forecast scenarios to determine an optimal initiative portfolio from among the plurality of portfolios.

2. A method of managing resource performance, comprising the steps of:
(a) collecting data pertaining to resource usage from a plurality of resources;
(b) analyzing the data including at least an analysis of environmental impact of the resource usage represented by the data;
(c) formulating at least one goal relating to improvement of resource usage or its effects;
(d) modeling a plurality of resource-based initiatives;
(e) assembling a plurality of initiative portfolios from the plurality of resource-based initiatives;
(f) modeling future performance of each of the plurality of initiative portfolios;
(g) selecting from the plurality of initiative portfolios an optimal portfolio, based at least in part on the results of the modeling future performance;
(h) implementing the resource-based initiatives associated with the selected initiative portfolio; and
(i) monitoring the performance of the plurality of implemented initiatives at least in part to measure the improvements in resource usage or environmental impact actually achieved by the initiatives implemented.
